(19) United States
(12) Patent Application Publication
(10) Pub. No.: US 2024/0427740 A1
(43) Pub. Date: Dec. 26, 2024

(54) Redundant Automation System and Method for Operation

(71) Applicant: Siemens Aktiengesellschaft, Muenchen (DE)

(72) Inventors: Thomas GROSCH, Roßtal (DE); Albert RENSCHLER, Ettlingen (DE)

(21) Appl. No.: 18/749,231

(22) Filed: Jun. 20, 2024

(30) Foreign Application Priority Data
Jun. 23, 2023 (EP) 23181251.2

(51) Int. Cl. G06F 16/178; G05B 23/02; G06F 16/176; G06F 21/62

(52) U.S. Cl. CPC G06F 16/178; G05B 23/0275; G06F 16/1774; G06F 21/6209

(57) ABSTRACT

A redundant automation system includes a first and second subsystems, which each have a control program for controlling a technical process and are each configured in an identical manner, and a synchronization connection between the first subsystem and the second subsystem, wherein in order to capture dynamic runtime data a first data reconciliator has a first file and a second file, where the first data reconciliator is configured to write the status information into the first and second files during a data collection phase, to keep the dynamic runtime data up to date via write accesses to the first and second files and, at the start of a synchronization phase, to lock further write accesses to the second file and to only permit write accesses to the first file, and to also transfer the locked second file to the second subsystem.

### BACKGROUND OF THE INVENTION

### 1. Field of the Invention

The invention relates to a redundant automation system comprising a first subsystem and a second subsystem, which each have a control program for controlling a technical process and which are configured in an identical manner, where a synchronization connection is present between the first subsystem and the second subsystem, status information, which comprises static configuration data and dynamic runtime data, is saved in the first subsystem, where the first subsystem has a first data reconciliator is configured to reconcile data of the status information of the first subsystem with status information of the second subsystem, and where the second subsystem has a second data reconciliator.

### 2. Description of the Related Art

In the field of automation, there is increasing demand for high-availability solutions (HA systems), which are suitable for reducing any potentially occurring downtimes of a plant to a minimum. The development of high-availability solutions of this kind is very cost-intensive, where an HA system that is conventionally used in the field of automation has two or more subsystems in the form of automation devices or computer systems coupled to one another via a synchronization connection. In principle, it is possible for both subsystems to have read and/or write access to these peripheral units connected to the HA system. One of the two subsystems is guiding in relation to the peripherals connected to the system. This means that outputs to peripheral units or output information for the peripheral units are only performed by one of the two subsystems, which operates as master or has assumed the function of master. In order for both subsystems to be able to run in sync, they are synchronized via the synchronization connection at regular intervals. In relation to the frequency of the synchronization and the extent thereof, it is possible to distinguish between various characteristics (warm standby, hot standby).

Moreover, it must also be ensured that, as part of the transfer of the process control from solo or non-redundant operation to redundant operation, such as after replacing a failed subsystem, this transfer or this transition is accomplished in a smooth manner. As part of a transfer of this kind, it is necessary to transfer relevant data from the subsystem that was previously guiding the process to the newly or additionally connected or applied subsystem. As part of this transfer, referred to as coupling and updating, during what is referred to as a coupling and update phase (CaU phase) the technical process to be controlled or the process control is not permitted to be influenced in a disruptive manner; the process control must continue to run without disruption during this CaU phase (referred to as update phase below for the sake of simplicity).

EP 2 667 269 B1 discloses a method for operating a redundant automation system. EP 2 657 797 B1 likewise describes a method for operating a redundant automation system.

During a synchronization, all status-relevant data is transferred from a programmable logic controller (PLC) that is currently still running to the PLC that is to be integrated into the redundant system. This status information also includes persistent data, which is usually saved in files on a file system. This persistent data is modified by the control program on an ongoing basis, such as when new logging data is to be saved on the file system. Data capture must also occur in an uninterrupted manner, even during the synchronization during which the same data has to be modified on an ongoing basis and synchronized with the newly added PLC.

In conventional methods or devices, the write access to the persistent data is locked during the sync-up procedure and the data is copied to the newly added PLC. Write access is only possible again for the control program once the synchronization or the update procedure has completed.

Accordingly, it is disadvantageous that the status information saved in the first subsystem, in particular current dynamic runtime data, can be lost or has to be temporarily stored in a complex manner.

### SUMMARY OF THE INVENTION

In view of the foregoing, it is an object of the present invention to provide a method that removes the foregoing disadvantage.

This and other objects and advantages are achieved in accordance with the invention by a method in which a first data reconciliator includes a first file and a second file, where the first data reconciliator is configured to write the status information both into the first file and into the second file during a data collection phase, the first data reconciliator keeps the dynamic runtime data up to date via write accesses to the first file and the second file, the first data reconciliator is configured to monitor whether neither write access to the first file nor write access to the second file fails during the data collection phase, and in the event that a write access fails, both write accesses are declared invalid, the first data reconciliator is further configured, at the start of a synchronization phase, to lock further write accesses to the second file and to only permit write accesses to the first file, furthermore to transfer the locked second file to the second subsystem, and the first data reconciliator is configured to save the further write accesses to the first file in a first recording file chronologically.

In addition, the second subsystem includes a second recording file, and the first data reconciliator is configured to likewise save the further write accesses to the first file into the second recording file (T2), the first data reconciliator is configured, after confirming the successful data transfer of the locked second file to the second subsystem, to start a completion phase in which the changes saved in the first recording file are entered into the second file on the first subsystem, the second data reconciliator is configured to enter the changes saved in the second recording file into the first file and into the second file on the second subsystem, the first data reconciliator is further configured to continue to save write accesses to the first file into the first recording file until all changes from the first recording file have been processed and, when all changes from the first recording file have been entered, to transition back into the data collection phase.

The data capture can now occur in an uninterrupted manner, because the data continues to be captured even during the synchronization phase, and during the completion phase the data that previously would have been lost without the invention is gradually embedded into the system again. One of the two subsystems is primarily in solo operation. Write accesses to persistent data are performed such that, in addition to the actual data, i.e., the first file, a copy of the persistent data is now also kept, namely the second file. Write accesses are also performed in duplicate. The write access is only successful if both accesses to the first file and the second file can be performed. If one of the two accesses or both accesses fail, then the write access also fails as a whole. On the first subsystem, write accesses are only performed on the first file during the synchronization phase. Read accesses are likewise provided from the first file of the first subsystem. In the case of read accesses, the second subsystem is provided with the data of the first subsystem from the first file. Initially, the second subsystem does not performed any write accesses to the first file and the second file.

Furthermore, it is provided that the first subsystem assumes guidance of the process and, in the event of a possible fault or a failure of the first subsystem, the second subsystem assumes guidance of the process, furthermore configured such that the failed or faulty first subsystem, after fault correction or a replacement, is updated with status information from the second subsystem that is still running, in order for its control program to once again operate in sync with the control program of the second subsystem, in order to assume guidance of the process should the respective subsystem fail again.

In order to reduce a later time lag, an update phase occurs on a supplementary basis for synchronization purposes. When the process control is transferred from solo or non-redundant operation to redundant operation, such as after replacing a failed subsystem, this transfer or this transition is to be accomplished in as smooth a manner as possible. As part of a transfer of this kind, it is necessary to transfer relevant data from the subsystem that was previously guiding the process to the newly or additionally connected or applied subsystem. As part of this transfer, referred to as coupling and updating, during what is referred to as a coupling and update phase (CaU phase) the technical process to be controlled or the process control is not permitted to be influenced in a disruptive manner. The process control must continue to run without disruption during this CaU phase (referred to as update phase below for the sake of simplicity).

To this end, the redundant automation system is configured to transfer the process control from solo operation of one of the subsystems to redundant control operation with the other subsystem, where the one subsystem is configured to transmit the second file in fragmented form to the other subsystem as part of an update phase via the synchronization connection and to temporarily save process input values and approvals by the one subsystem, where the approvals show which processing segments of the control program the one subsystem has already processed, in this case the other subsystem is further embodied, after receiving the second file, to process approved processing segments of a control program, which correspond to the processing segments of the control program of the one subsystem, while taking into consideration the temporarily stored process input values with a time lag, where the automation system is configured to process the processing segments of the control program more quickly relative to the processing of the processing segments of the control program in order to reduce the time lag of the processing to a predefined value.

In order to reduce a communication load, the redundant automation system is configured such that the first data reconciliator breaks down the second file into data pieces for the fragmented transfer, where the size of the data pieces is chosen such that it does not have a negative influence on a responsiveness of the first subsystem due to the additional load for the data transfer.

The objects and advantages in accordance with the invention are also achieved by a method for operating a redundant automation system, where a first subsystem and a second subsystem each process a control program in order to control a technical process, where the first subsystem guides the process with a first control program and the second subsystem processes a second control program in sync such that, in the event of a failure of one of the two subsystems, the subsystem that has failed or is faulty in each case, after fault correction or a replacement, is updated with status information from the subsystem that is still running via a data reconciliator, in order to operate in sync with its control program again, in order to assume guidance of the process in the event of a repeat failure of the respective subsystem, where the status information comprises static configuration data and dynamic runtime data, where a first file and a second file are created in the first subsystem, a first data reconciliator in the first subsystem starts a data collection phase, in which the status information is written both into the first file and into the second file, the first data reconciliator keeps the dynamic runtime data up to date via write accesses to the first file and the second file, the data reconciliator monitors during the data collection phase that neither write access to the first file nor write access to the second file fails, and in the event that a write access has failed, both write accesses are declared invalid, the first data reconciliator starts a synchronization phase following the data collection phase and, at the start of the synchronization phase, further write accesses to the second file are locked and write accesses are only possible to the first file. Furthermore, the locked first file is transferred to the second subsystem, in this case via the first data reconciliator the further write accesses to the first file are saved in a first recording file chronologically, in the second subsystem the further write accesses to the first file are likewise written into a second recording file via the first data reconciliator, into the second recording file, after confirming the successful data transfer of the locked second file to the second subsystem, a completion phase is started via the first data reconciliator in which the changes saved in the first recording file are entered into the second file on the first subsystem, the changes saved in the second recording file are entered into the first file and into the second file on the second subsystem via the second data reconciliator, the write accesses to the first file continue to be saved in the first recording file by the first data reconciliator until all changes from the first recording file have been entered and, when all changes from the first recording file have been entered, there is a transition back into the data collection phase.

The methods previously used lock the write access during the sync-up procedure or update procedure. The present inventive method, in contrast, allows the control program to also have write access to the persistent data during the sync-up procedure. The advantage lies in the uninterrupted capture of the persistent data, even during the sync-up procedure. The control program therefore does not need to implement any particular behavior for the sync-up procedure (for example, temporarily storing the data), which simplifies the realization of the control program and reduces the testing effort.

In order for parameters (for example, regulating parameters, position values, limit values) to be retained beyond POWER OFF and restarting of a subsystem, these have to be backed up in a persistent manner in advance. The parameters can be backed up as remanent data or using the write functionality of a PLC, such as in a CSV file.

In the context of the invention, “persistence” is understood in information technology as the property of a system of keeping the status of its data, its object model and/or its logical connections available over a long time, in particular beyond a planned or unplanned program termination. For this, a non-volatile storage medium is required; the file system or a database as well as a bidirectional and transaction-oriented data transfer backed-up by logs can also be considered a non-volatile medium. As a program can be interrupted at any time in an unexpected manner, persistent data storage particularly means that any status change of the data has to be immediately saved on the non-volatile medium.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention, its embodiments as well as its advantages are explained in further detail below on the basis of the drawings, which illustrate an exemplary embodiment of the invention, in which:

FIG. 1 shows a sequence of a temporally asynchronous coupling of two subsystems in accordance with the invention;

FIG. 2 shows an update sequence in accordance with the invention;

FIG. 3 shows a redundant automation system in accordance with the prior art;

FIG. 4 shows the redundant automation system with data reconciliator in accordance with the invention;

FIG. 5 shows a sequence of the synchronization with the first and the second file in the first subsystem in accordance with the invention; and

FIG. 6 is a flowchart of the method in accordance with the invention.

### DETAILED DESCRIPTION OF THE EXEMPLARY EMBODIMENTS

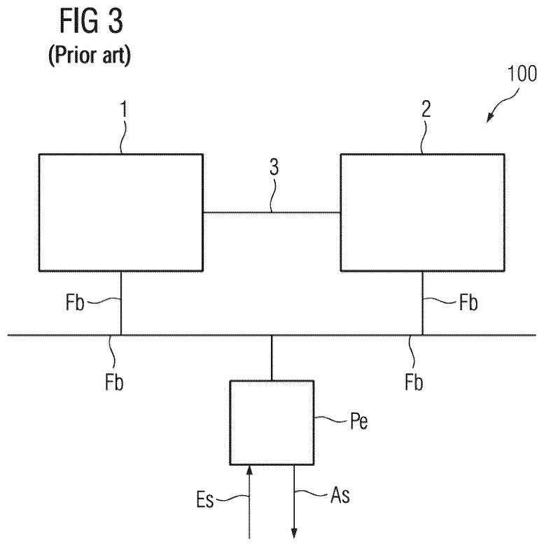

Reference is first made to FIG. 3 (prior art), which shows a conventional redundant automation system 100 comprising two subsystems. A first subsystem 1 and a second subsystem 2 are connected to a peripheral unit Pe via a fieldbus Fb. Here, the fieldbus Fb meets the PROFINET 10 specification, for example. In principle, other bus systems are also suitable, for example, Ethernet, Fieldbus, Modbus, Profibus or other parallel bus systems. The peripheral unit Pe obtains signals from measuring transmitters or measuring transducers, which are used for capturing a process status, via input lines Es and outputs signals to actuators, with which the process is influenced, via output lines As. The process as well as the measuring transmitters, measuring transducers and actuators are not shown in the FIG. 3 for the sake of clarity. The two subsystems 1,2 process the same control program in a cyclical and synchronous manner. For the synchronization thereof, a synchronization connection 3 is provided, where the redundancy and monitoring functions are implemented via said synchronization connection 3.

As explained, from a point in time at which an update phase is completed, the automation system 100 operates in a redundant operating manner and, with regard to the process control, a subsystem 1,2 is transferred from the solo operation into the redundant operation with a further subsystem. From this point in time, both subsystems 1,2 run through the same program paths with events in sync, for example, due to an event in the form of a process alarm, where the run-through via the first subsystem 1 and the run-through via the second subsystem 2 preferably occurs in an asynchronous manner.

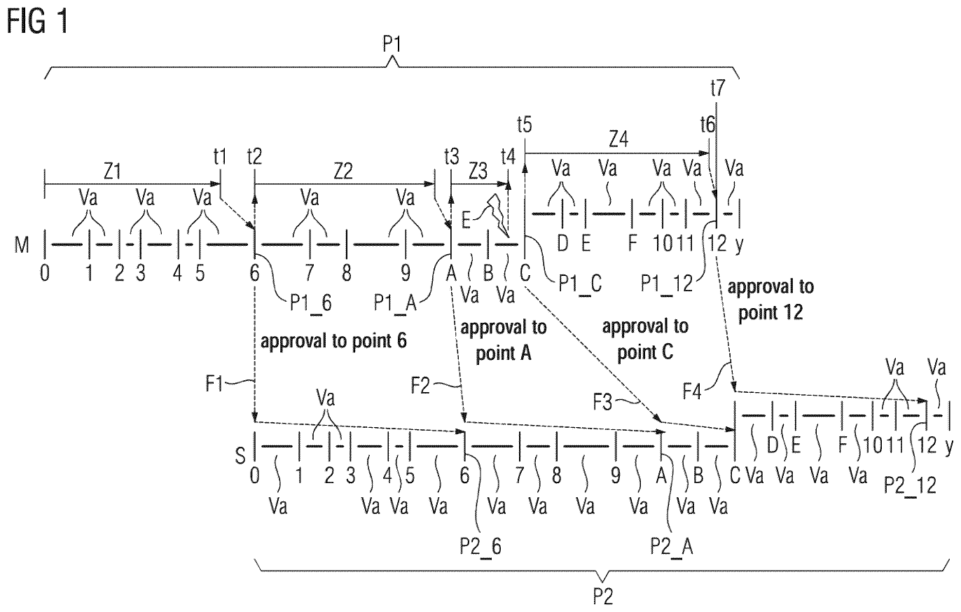

To explain a processing of the control programs P1,P2 with events in sync and for better understanding of the invention, to this end reference is made below to FIG. 1, which shows a proposed sequence of a temporally asynchronous coupling of the two subsystems 1,2. In this context, “processing with events in sync” means that both the master and the slave run through the same program paths of the respective control program due to an event, where the run-throughs occurs in a temporally asynchronous manner.

It is assumed that one of the subsystems 1,2 is operated as master M and one of the subsystems 1,2 is operated as slave S or reserve. The master M is therefore guiding with regard to the control of a technical process, and assumes the process control, where the master M reads the process input information or process input values from the peripheral unit Pe (FIG. 3) and provides these to the slave S in a temporally asynchronous manner. The slave S then assumes the function of master or master role, if the master M fails due to disruption.

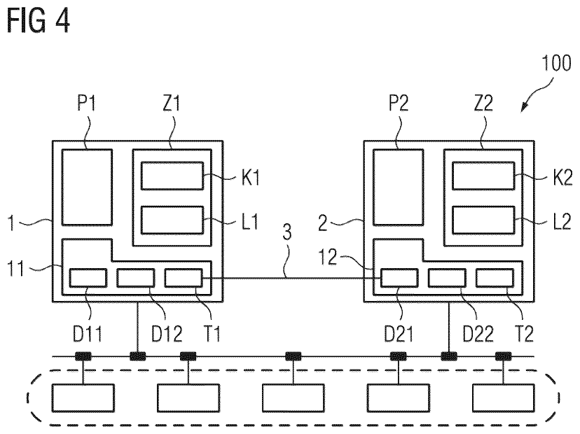

The master M processes a program P1 for controlling the technical process, where the slave S also processes a second control program P2 that corresponds to this first control program P1. Both control programs P1,P2 have a large number of processing segments Va of different duration, where the control programs P1,P2 can be interrupted at the respective beginning and the respective end of each processing segment Va. Beginning and end of each processing segment Va, which conventionally comprises a large number of program codes, thus represent interruptible program or interruption points 0, 1, 2, . . . y. At these interruption points 0, 1, 2, . . . y, the respective control program P1, P2 can be interrupted if necessary via the master M and the slave S, in order to be able to initiate suitable responses after the occurrence of an event or a process alarm. Furthermore, at these interruption points 0, 1, 2, . . . y, the respective control program P1, P2 can be interrupted, so that the master M and the slave S can exchange approvals, acknowledgements or other information via the fieldbus Fb or via the synchronization connection Sv (FIG. 4). After a respective predeterminable or predetermined time interval Zi, i=1, 2, . . . has elapsed and at the respective point in time of the occurrence of an interruption point that follows after the respective time interval Zi has elapsed (preferably the first interruption point that follows the respective time interval Zi), the master M transmits to the slave S an approval or an approval signal, which indicates to the slave S the processing segment Va up to which the slave S is permitted to process the control program P2. These processing segments Va of the control program P2 correspond to those that the master M has already processed during the processing of the control program P1.

In the present exemplary embodiment, it is assumed that after a time interval Z1 has elapsed, at a point in time t1 and at a point in time t2, at which a first interruption point P1_6 (interruption point 6) follows the time interval Z1, the master M transmits an approval F1 to the slave S. This approval F1 comprises the information for the slave S that the slave is permitted to process its control program P2 to be processed up to an interruption point P2_6 (interruption point 6), where the interruption point P2_6 of the control program P2 corresponds to the interruption point P1_6 of the control program P1. This means that, due to the approval, the slave S can process the processing segments Va of the control program P2 that correspond to the processing segments Va of the control program P1 up to the point in time of the generation of the approval or of the approval signal, where in the example it is assumed for the sake of simplicity that the point in time of the generation of the approval corresponds to the point in time of the transmitting of the approval to the slave S. The processing of these processing steps Va via the slave S thus occurs temporally asynchronously to the processing of the corresponding processing segments Va via the master M, where after the processing of the processing segments Va of the control program P2 by the slave S, a processing of further processing segments Va by the slave S only takes place when the master M transmits a further approval to the slave S.

The point in time of the occurrence of this interruption point P1_6, P2_6 (interruption point 6) represents the beginning of a time interval Z2 that follows the time interval Z1.

The further temporally asynchronous processing of the control programs P1, P2 occurs in the manner described. At a point in time t3 of the occurrence of a first interruption point P1_A after the time interval Z2 has elapsed, the master M transmits a further approval F2 to the slave S, which indicates to the slave S that it can process these further processing segments Va up to the interruption point P2_A. These processing segments Va in turn correspond to those that the master M has already processed from the point in time t2 to point in time t3, i.e. up to interruption point P1_A. This means that the slave S processes the processing segments Va from the point in time t2 of the previous approval F1 to the point in time t3 of the current approval F2. The point in time t3, at which the first interruption point P1_A has occurred after the time interval Z2 has elapsed, is the beginning of a time interval Z3 that follows the time interval Z2.

It can now occur that an event, such as an event in the form of a process alarm, occurs during a time interval. In the exemplary embodiment, such an event is designated by E, to which the master M must react suitably during the time interval Z3 at a point in time t4 in accordance with the control program P1. Here, the master M transfers an approval F3 to the slave S not at a point in time of the occurrence of an interruption point that follows the time interval Z3 after the time interval Z3, but at a point in time t5 of the occurrence of an interruption point P1_C (interruption point C) that follows the occurrence of the event E. This means that the time interval Z3 is shortened due to the event E, where the point in time t5 is the beginning of a following time interval Z4. Due to the approval F3 transmitted to the slave S, the slave S processes the processing segments Va of the control program P2 that correspond to the processing segments Va of the first control program P1 that the master M has already processed between the points in time t3 and t5.

Due to the event E, the master M processes processing segments Va of higher priority during the time interval Z4, for example, the master M undertakes a change of thread at point in time t5, and in turn, after the time interval Z4 has elapsed, at point in time t6 transmits an approval F4 at a point in time t7, at which a first interruption point P1_12 (interruption point 12) that follows the time interval Z4 occurs. Due to this approval, the slave S likewise processes processing segments Va up to an interruption point P2_12 (interruption point 12) of the control program P2, where these processing segments Va correspond to the processing segments Va of the control program P1 between the points in time t5 and t7 and where the slave S likewise undertakes a change of thread.

As explained, the approvals of the master M enable the slave S to run through the same “thread stack” as the master M, which means that the slave S undertakes a “change of thread” at a point in the control program P2 that corresponds to the point in the control program P1. The slave S only continues its processing when it is requested to do so by the master M by way of an approval. With regard to the processing of the processing segments, the master M processes these in real time in the manner of a standalone operation or in the manner of a non-redundant operation and at regular intervals and also, after the occurrence of events, issues approvals for processing corresponding processing segments via the slave S, where the master M continues to process the first control program P1 and does not actively await a response of the slave S. The slave S executes behind the master M in relation to the processing of the corresponding processing segments and processes the segments due to the master approvals issued.

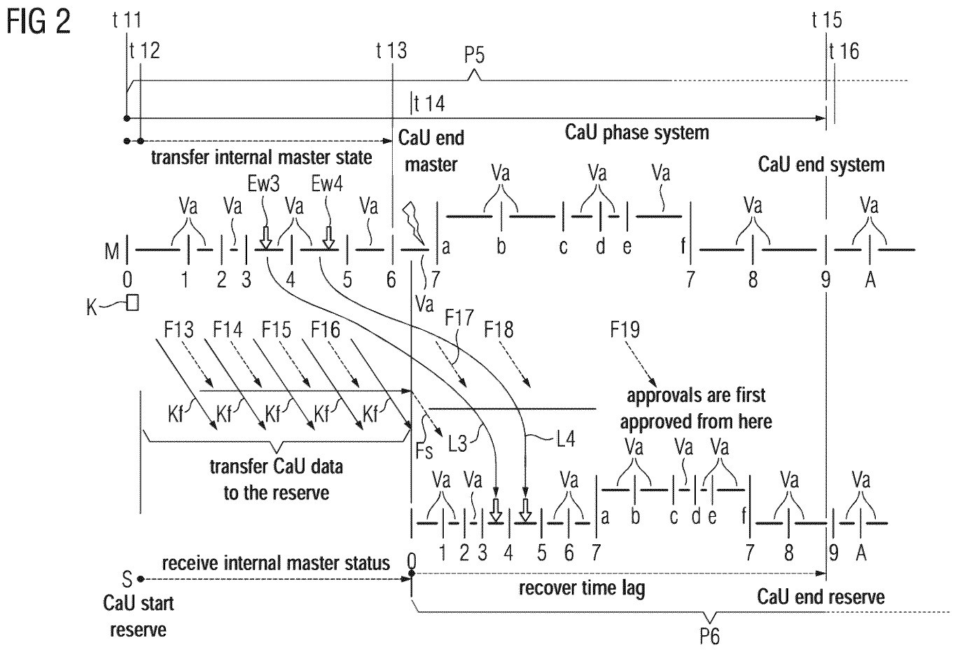

In the following, it is assumed that the process control is to be transferred from solo operation of the master M to redundant control operation with the slave S. A transfer of this kind is necessary, for example, if the slave S is coupled to the master M again after a repair. To this end, reference is made to FIG. 2, which shows an update sequence of the automation system 100.

This transfer beings at a point in time t11, by which the master M has identified that the slave S is coupled to the fieldbus Fb (FIG. 3), where the update phase both of the master M and of the slave S begins from this point in time t11. From this point in time t11, the master M creates a local copy K of all relevant data, which represents its internal status at this point in time t11, where the master M continues to control the technical process in solo operation and processes processing segments Va of a control program P5. From a point in time t12 to a point in time t13, at which the update phase of the master M is completed, the master M transmits this copy K to the slave S in fragmented form (which is indicated in the drawing by means of arrows Kf) that the slave S has fully received at a point in time t14. At this point in time t14, the slave S now has the same internal status as the master at the point in time t11. From the point in time t12, furthermore all approvals of the master M as well as all process input values read-in by the master M from the peripheral unit Pe (FIG. 3) are temporarily stored on the master M, the slave S or a further subsystem of the automation system, where the approvals are only approved for processing by the slave S after the copy K has been fully received. In the present exemplary embodiment, it is assumed that during a time segment from the point in time t11 to the point in time t13, at which the transfer of the copy K is completed, the master M running in solo operation has generated approvals F13, F14, F15, F16 and has further read in process input values Ew3, Ew4. These approvals F13 to F16 and these process input values Ew3, Ew4 are approved for the slave S only from a point in time t14, i.e., at the point in time at which the internal status of the master M is fully provided to the slave S, which is indicated in the figure by an arrow Fs and by curved lines L3, L4. After this approval by the master M, the slave S brings itself to the internal status of the master M, in that the slave S processes the data of the copy K in accordance with the approvals F13 to F16. Here, the slave S processes the processing segments Va of its control program P6, which correspond to the processing segments Va of the control program P5 of the master M up to point in time t13, where the slave S takes into consideration the process input values Ew3, Ew4 with regard to the processing of the control program P6.

Due to the slave S bringing itself to the internal status of the master M in a temporally asynchronous manner, with regard to the processing of the corresponding processing segments Va of the control program P6, the slave S executes behind the master M, where this time lag must be reduced to a tolerable level, since a time lag that is too high can lead to a loss of redundancy. In order to reduce this time lag, there is provision for the processing speed of the slave S to be higher relative to the processing speed of the master M, which is shown in the figure in the form of processing segments Va in the control program P6 that are shown in a “shortened” manner. This relative increase in the processing speed of the slave S can be brought about, for example, by the slave S processing the processing segments Va of its program P6 more quickly or the master M processing the processing segments Va of its program P5 more slowly. Only when the time lag is recovered or reduced to a tolerable level or a predefined value is the update phase of the slave S beginning at point in time t12 and thus of the automation system 100 completed.

In the present exemplary embodiment, it is assumed that the time lag has been reduced to a tolerable level at a point in time t15. This level is chosen or predefined such that, in the event of a failure of the master M, the slave can assume the master role in a smooth manner. In the figure, the temporal difference between a point in time t16 and the point in time t15 represents the tolerable level, which in a practical exemplary embodiment of the invention lies in the millisecond range. As part of the update phase of the slave S, the slave S, from the point in time t14 to point in time t15, processes both the approvals F13 to F16 temporarily stored during the transfer of the copy K and also approvals F17, F18, F19 that the master M transmits to the slave S after this transfer. These approvals F17 to F19 indicate to the slave S that processing segments Va of the control program P6 are further to be processed by the slave S, where these processing segments Va correspond to the processing segments Va of the control program P5 that the master M has already processed from point in time t14. In other words: Once the master M has fully transmitted the copy K to the slave S or the slave S has fully received this copy K, the slave S, from point in time t14 to point in time t16, processes all approved processing segments Va of its control program P6 that correspond to those that the master M has already processed from point in time t11 to point in time t15.

From point in time t15, the update phase is completed and the automation system 100 is transferred into redundant operation. The process control has changed from solo operation of the master M to redundant operation with the slave S, where the further run-throughs of the corresponding program paths can occur on the master M and the slave S from the point in time t16 temporally asynchronously in the manner described or temporally in sync in a per se known manner.

FIG. 4 shows the previously described automation system 100 with the expansion of the data reconciliator 11,12, in this case the first subsystem 1 has a first data reconciliator 11 and the second subsystem 2 has a second data reconciliator 12. The first subsystem 1 has the first control program P1 for controlling the technical process, and the second subsystem 2 has the second control program P2, likewise for controlling the technical process. In order to synchronize the first subsystem 1 with the second subsystem 2, the synchronization connection 3 is provided. Saved in the first subsystem 1 is status information Z1, which comprises static configuration data K1 and dynamic runtime data L1. The first subsystem 1 with its first data reconciliator 11 is configured to reconcile data of the status information Z1 of the first subsystem 1 with status information Z2 of the second subsystem 2, where the second subsystem 2 has the second data reconciliator 12.

The first data reconciliator 11 has a first file D11 and a second file D12. The first data reconciliator 11 is configured to write the status information Z1 both into the first file D11 and also into the second file D12 during a data collection phase PH1. The first data reconciliator 11 keeps the dynamic runtime data L1 up to date via write accesses to the first file D11 and the second file D12. The first data reconciliator 11 is configured to monitor whether neither write access to the first file D11 nor write access to the second file D12 fails during the data collection phase PH1, and in the event that a write access fails, both write accesses are declared invalid. Furthermore, the first data reconciliator 11 is configured, at the start of a synchronization phase PH2, to lock further write accesses to the second file D12 and to only permit write accesses to the first file D11. The locked second file D12 is then transferred to the second subsystem 2. This transferring of the second locked file D12 to the second subsystem 2 corresponds to the transferring of the local copy K from the master M to the slave S described by FIG. 2. In order to avoid data losses, the first data reconciliator 11 is now configured to save the further write accesses to the first file in a first recording file P1 chronologically. The second subsystem 2 has a second recording file T2, and the first data reconciliator 11 is furthermore configured to likewise save the further write accesses to the first file D11 into the second recording file T2.

The first data reconciliator 11 is configured, after confirming the successful data transfer of the locked second file D12 to the second subsystem 2, to start a completion phase PH3. In this completion phase PH3, the changes saved in the first recording file T1 are entered into the second file D12 on the first subsystem 1. The second data reconciliator 12 is configured to enter the changes saved in the second recording file T2 into the first file D21 and into the second file D22 on the second subsystem 2. The first data reconciliator 11 is configured to continue to save write accesses to the first file D11 into the first recording file T1 until all changes from the first recording file T1 have been processed and, when all changes from the first recording file T1 file have been entered, to transition back into the data collection phase PH1.

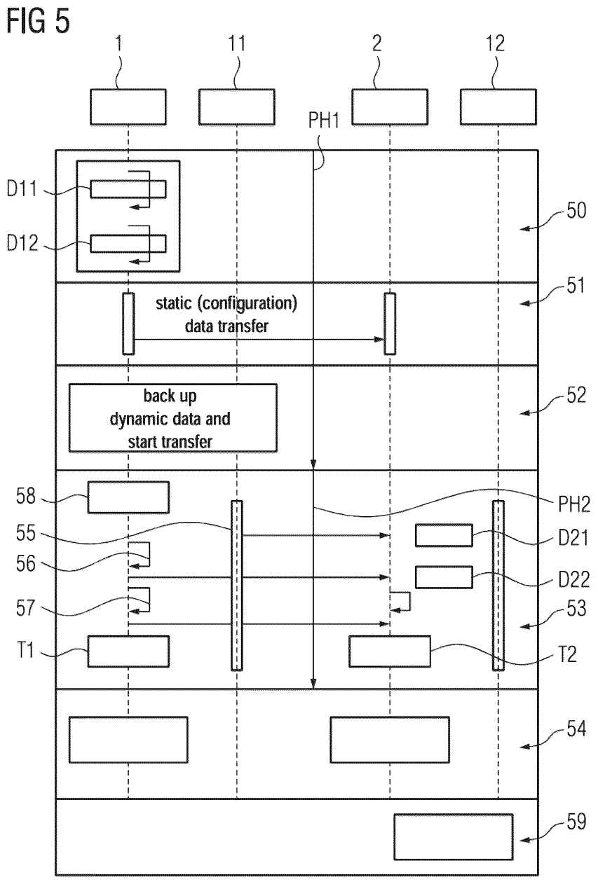

According to FIG. 5, the sequence in accordance with the method for “updating” or synchronizing from the first subsystem 1 to the second subsystem 2 is shown. The first subsystem 1 first runs in solo operation 50. A first file D11 and a second file D12 are created in the first subsystem 1. The first data reconciliator 11 in the first subsystem 1 starts a data collection phase PH1, in which the status information Z1 is written both into the first file D11 and also into the second file D12. The first data reconciliator 11 writes the dynamic runtime data L1 to the first file D11 and the second file D12. In the data collection phase PH1, first static configuration data can already be transferred in the step Start Synchro 51. Following the data collection phase PH1, the synchronization phase PH2 is started. At the beginning of the synchronization phase PH2, the second file D12 is locked for further data accesses and write accesses in a locking step 58. Write accesses are only permitted to occur on the first file D11. The now-locked second file D12 is transferred to the second subsystem 2. This starts the data transfer 55. The second file D12 has been locked in step 58. 56 symbolizes that now only read accesses to the first file D11 can occur, and 57 symbolizes that only write accesses to the first file D11 can occur.

With the first data reconciliator 11, further write accesses to the first file D11 are saved chronologically in a first recording file T1; in the second subsystem 2 the further write accesses to the first file D11 are written into the second recording file T2 in a second recording file T2 via the first data reconciliator 11. If the data transfer is completed in step 54, then the successful data transfer of the locked second file D12 is confirmed to the second subsystem 2. In a completion phase PH3, the changes saved in the first recording file T1 are now entered into the second file D12 on the first subsystem 1. With the second data reconciliator 12, the changes saved in the second recording file T2 are entered into the first file D21 and into the second file D22 on the second subsystem 2. In step 59, both recording files T1,T2 are now emptied again and all files or recorded write accesses have been entered. If all changes from the first recording file T1 have been entered, then there is a transition back into the data collection phase PH1.

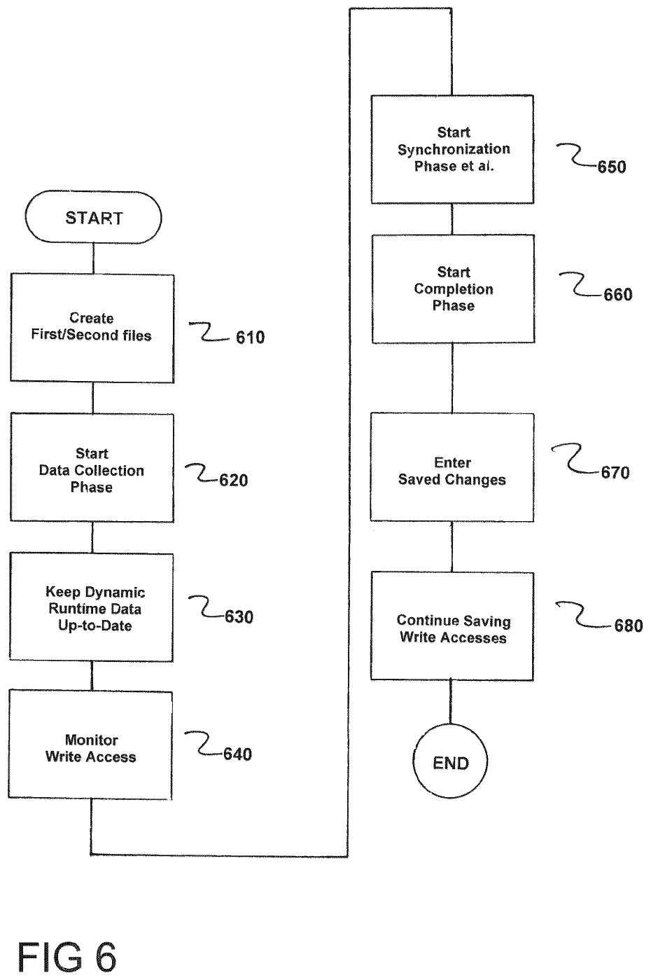

FIG. 6 is a flowchart of the method for operating a redundant automation system, where a first subsystem 1 and a second subsystem 2 for controlling a technical process each process a control program P1,P2, the first subsystem 1 guides the process with a first control program P1 and the second subsystem 2 processes a second control program P2 in sync such that, and in an event of a failure of one subsystem of the first and second subsystems 1,2, a subsystem 1,2 that has failed or is faulty in each case, after fault correction or a replacement, is updated with status information Z1,Z2 from a subsystem 1,2 which is still running via a data reconciliator 11,12, to again operate in sync with its control program P1,P2, to assume guidance of the process in an event of a repeat failure of the respective subsystem 1,2, and the status information Z1,Z2 comprises static configuration data K1,K2 and dynamic runtime data L1,L2.

The method comprises creating a first file D11 and a second file D12 in the first subsystem 1,2, as indicated in step 610.

Next, a first data reconciliator 11 in the first subsystem 1 starts a data collection phase PH1 during which the status information Z1 is written into the first and second files D11, D12, as indicated in step 620.

Next, the first data reconciliator 11 keeps the dynamic runtime data L1 up to date via write accesses to the first and second files D11,D12, as indicated in step 630.

Next, the data reconciliator 10, during the data collection phase P1 monitors whether neither write access to the first file D11 nor write access to the second file d12 fails, and both write accesses are declared invalid when a write access has failed, as indicated in step 640.

Next, the first data reconciliator 11 starts a synchronization phase PH2 following the data collection phase PH1 and, at the start of the synchronization phase PH2, further write accesses to the second file D12 are locked, write accesses are only possible to the first file D11 are ensured, and the locked first file D12 is transferred to the second subsystem 2, as indicated in step 650. Here, the further write accesses to the first file D11 are saved in a first recording file T1 chronologically via the first data reconciliator 11, and in the second subsystem 2 the further write accesses to the first file D11 are written into a second recording file T2 via the first data reconciliator 11 into the second recording file T2.

Next, after confirming the successful data transfer of the locked second file D12 to the second subsystem 2, a completion phase P3 is started via the first data reconciliator 11 during which the changes saved in the first recording file T1 are entered into the second file D12 on the first subsystem 1, as indicated in step 660.

Next, the changes saved in the second recording file T2 are entered into the first and second files D21,D22 on the second subsystem 1 via the second data reconciliator 12, as indicated in step 670.

Next, to save the write accesses to the first file D1 are continued to be saved in the first recording file T1 by the first data reconciliator 11 until all changes from the first recording file T1 have been entered and, when all changes from the first recording file T1 have been entered, a transition back into the data collection phase PH1 is performed, as indicated in step 680.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A redundant automation system comprising:
a first subsystem;
a second subsystem, each of the first and second subsystems having a respective control program for controlling a technical process and being configured in an identical manner;
a synchronization connection operatively coupled between the first subsystem and the second subsystem;
wherein status information is saved in the first subsystem, said status information comprising static configuration data and dynamic runtime data;
wherein the first subsystem includes a first data reconciliator configured to reconcile data of the status information of the first subsystem with status information of the second subsystem;
wherein the second subsystem includes a second data reconciliator;
wherein the first data reconciliator includes a first file and a second file;
wherein the first data reconciliator is further configured to write the status information into the first and second files during a data collection phase;
wherein the first data reconciliator keeps the dynamic runtime data up to date via write accesses to the first and second files;
wherein the first data reconciliator is further configured to monitor whether neither write access to the first file nor write access to the second file fails during the data collection phase, such that both write accesses are declared invalid when a write access fails;
wherein the first data reconciliator is further configured, at a start of a synchronization phase, to lock further write accesses to the second file and to only permit write accesses to the first file, and furthermore to transfer the locked second file to the second subsystem;
wherein the first data reconciliator is further configured to save the further write accesses to the first file in a first recording file chronologically;
wherein the second subsystem includes a second recording file, and the first data reconciliator is further configured to save the further write accesses to the first file into the second recording file;
wherein the first data reconciliator is further configured, after confirming a successful data transfer of the locked second file to the second subsystem, to start a completion phase in which changes saved in the first recording file are entered into the second file on the first subsystem;
wherein the second data reconciliator is further configured to enter changes saved in the second recording file into the first file and into the second file on the second subsystem; and
wherein the first data reconciliator is further configured to continue to save write accesses to the first file into the first recording file until all changes from the first recording file have been processed and, when all changes from the first recording file file have been entered, to transition back into the data collection phase.

2. The redundant automation system as claimed in claim 1, wherein redundant automation system is configured such that the first subsystem assumes guidance of the process and, in an event of a possible fault or a failure of the first subsystem, the second subsystem assumes guidance of the process, and is further configured such that the failed or faulty first subsystem, after fault correction or a replacement, is updated with status information from the second subsystem which is still running, in order for its control program to once again operate in sync with the control program of the second subsystem, in order to assume the guidance of the process should the respective subsystem fail again.

3. The redundant automation system as claimed in claim 1, wherein the redundant automation system is configured to transfer the process control from solo operation of one subsystem of the first and second subsystems to redundant control operation with another subsystem of the first and second subsystems;
wherein the one subsystem of the first and second subsystems is configured to transmit the second file in fragmented form to the other subsystem as part of an update phase via the synchronization connection and to temporarily save process input values and approvals to by the one subsystem of the first and second subsystems;
wherein the approvals show which processing segments of the control program which the one subsystem of the first and second subsystems has already processed, the other subsystem of the of the first and second subsystems being further configured, after receiving the second file, to process approved processing segments of its control program, which correspond to the processing segments of the control program of the one subsystem, while taking into consideration the temporarily stored process input values with a time lag; and
wherein the redundant automation system is further configured to process the processing segments of the control program more quickly relative to the processing of the processing segments of the control program to reduce the time lag of the processing to a predefined value.

4. The redundant automation system as claimed in claim 2, wherein the redundant automation system is configured to transfer the process control from solo operation of one subsystem of the first and second subsystems to redundant control operation with another subsystem of the first and second subsystems;
wherein the one subsystem of the first and second subsystems is configured to transmit the second file in fragmented form to the other subsystem as part of an update phase via the synchronization connection and to temporarily save process input values and approvals by the one subsystem of the first and second subsystems;
wherein the approvals show which processing segments of the control program which the one subsystem of the first and second subsystems has already processed, the other subsystem of the of the first and second subsystems being further configured, after receiving the second file, to process approved processing segments of its control program, which correspond to the processing segments of the control program of the one subsystem, while taking into consideration the temporarily stored process input values (with a time lag; and
wherein the redundant automation system is further configured to process the processing segments of the control program (P2) more quickly relative to the processing of the processing segments of the control program to reduce the time lag of the processing to a predefined value.

5. The redundant automation system as claimed in claim 3, wherein the first data reconciliator breaks down the second file into data pieces for the fragmented transfer; and
wherein a size of the data pieces is chosen such that it does not have a negative influence on a responsiveness of the first subsystem due to an additional load for the data transfer.

6. A method for operating a redundant automation system, a first subsystem and a second subsystem for controlling a technical process each processing a control program, the first subsystem guiding the process with a first control program and the second subsystem processing a second control program in sync such that, in an event of a failure of one subsystem of the first and second subsystems, a subsystem which has failed or is faulty in each case, after fault correction or a replacement, being updated with status information from a subsystem which is still running via a data reconciliator, to again operate in sync with its control program, to assume guidance of the process in an event of a repeat failure of the respective subsystem, and the status information comprising static configuration data and dynamic runtime data, the method comprising:
creating a first file and a second file in the first subsystem;
starting, by a first data reconciliator in the first subsystem, a data collection phase during which the status information is written into the first and second files;
keeping, by the first data reconciliator, the dynamic runtime data up to date via write accesses to the first and second files;
monitoring, by the data reconciliator, during the data collection phase whether neither write access to the first file nor write access to the second file fails, and declaring both write accesses invalid when a write access has failed;
starting, by the first data reconciliator, a synchronization phase following the data collection phase and, at the start of the synchronization phase, locking further write accesses to the second file, ensuring write accesses are only possible to the first file, and transferring the locked first file to the second subsystem, the further write accesses to the first file being saved in a first recording file chronologically via the first data reconciliator, and in the second subsystem the further write accesses to the first file being written into a second recording file via the first data reconciliator into the second recording file;
starting, after confirming the successful data transfer of the locked second file to the second subsystem, a completion phase via the first data reconciliator during which the changes saved in the first recording file are entered into the second file on the first subsystem;
entering the changes saved in the second recording file into the first and second files on the second subsystem via the second data reconciliator; and
continuing to save the write accesses to the first file in the first recording file by the first data reconciliator until all changes from the first recording file have been entered and, when all changes from the first recording file have been entered, transitioning back into the data collection phase.
